(19) United States
(12) Patent Application Publication
(10) Pub. No.: US 2017/0070176 A1
(43) Pub. Date: Mar. 9, 2017

(54) ELECTRIC DRIVE SYSTEM

(71) Applicant: Robert Bosch GmbH, Stuttgart (DE)

(72) Inventors: Carsten Schroeder, Tamm (DE); Martin Braun, Neustetten-Wolfenhausen (DE); Stefan Butzmann, Schalksmühle (DE)

(21) Appl. No.: 15/121,949

(22) PCT Filed: Jan. 8, 2015
(86) PCT No.: PCT/EP2015/050223

§ 371 Date: Aug. 26, 2016

(30) Foreign Application Priority Data
Feb. 27, 2014 (DE) 102014 203 550.3

(51) Int. Cl. H02P 27/06; H02P 25/08; B60L 11/18; H02P 25/03

(52) U.S. Cl. CPC H02P 27/06; H02P 25/03; H02P 25/08; B60L 11/1803; B60L 11/1864; B60L 2220/14; B60L 2220/16; B60L 2220/18

(57) ABSTRACT

The invention relates to an electric drive system, comprising an n-phase electric machine, n>1, which has at least two single-phase winding strands, a first inverter, the output connection of which is connected to the phase connection of a first of the single-phase winding strands of the electric machine, at least one second inverter, the output connection of which is connected to the phase connection of a second of the single-phase winding strands of the electric machine, and a DC voltage source which has a plurality of series-connected battery modules and the output connections of which are respectively connected to the input connections of the first inverter and to the input connections of the second inverter, so that the first inverter and the second inverter are arranged in parallel.

### BACKGROUND OF THE INVENTION

The invention relates to an electric drive system, in particular for an electrically operated vehicle such as an electric car or a hybrid vehicle.

As is depicted in FIG. 1 by way of example, the feed of an electric machine 101 takes place in an electric drive system 100 typically by means of an inverter 102 in the form of a pulse width modulated inverter. To this end, a DC voltage provided by a DC voltage intermediate circuit 103 can be converted into a multi-phase AC voltage, for example a three-phase AC voltage. The DC voltage intermediate circuit 103 is fed by a string consisting of series-connected battery modules 105 or any desired DC voltage sources.

In order to be able to meet the requirements for power and energy given for a respective application, a plurality of battery modules or battery cells are frequently connected in series in an energy storage system. If however high power outputs are required from the electric machine, it may be necessary to take measures in implementing the electric drive system 100 that meet the increased power output requirements.

It can, for example, be possible to connect a plurality of strings 104 consisting of series-connected battery modules 105 in parallel. This can however lead to undesired compensation currents between the strings 104. In addition, it may also be necessary to increase the current carrying capacity of the inverter 102 and the electric machine 101. Alternatively, the intermediate circuit voltage could also be raised. In any case, extensive adaptations and changes in the implementation of the electric drive system will be necessary, which in turn lead to increased implementation effort and costs.

The American patent publication US 2007/0070667 discloses a drive system for an electrically operated vehicle comprising multiple inverters connected in parallel, which supply AC voltage to a multi-phase motor. The German patent publication DE 10 2011 085 731 A1 discloses an electric drive system for a six-phase motor comprising two inverters connected in parallel. The German patent publication DE 10 2008 008 978 A1 discloses modular drive converters. The German patent publication DE 10 2010 001 250 A1 discloses an electric drive system for an electric machine comprising two phase systems, which are fed via separate inverters.

### SUMMARY OF THE INVENTION

According to a first aspect, the present invention relates to an electric drive system, comprising an n-phase electric machine, n>1, which has at least two single-phase winding strands, a first inverter, the output connection of which is connected to the phase connection of a first of the single-phase wiring strands of the electric machine, at least one second inverter, the output connection of which is connected to the phase connection of a second of the single-phase winding strands of the electric machine, and a DC voltage source which has a plurality of series-connected battery modules and the output connections of which are respectively connected to the input connections of the first inverter and to the input connections of the second inverter, so that the first inverter and the second inverter are arranged in parallel.

A concept of the present invention is to actuate electric machines with the help of standardized power modules, such as inverters, for example in B6 topology. Such inverters are available as standardized module types which can be cost effectively procured and implemented by means of economy of scale effects. The performance of the electric drive system is advantageously increased by the modularization of the power modules without the design of the electric machine or the individual power modules being more complicated or cost intensive per se. Simple mechanical connection means, by means of which the system modules can be interconnected, can furthermore be provided for all of the power modules. In addition, a central control device, for example on a central control circuit board, can be similarly provided for all power modules.

According to one embodiment of the electric drive system according to the invention, the first and the second inverter can each have a single-phase, self-piloted inverter which comprises a symmetrical half bridge consisting in each case of two power semiconductor switches connected in series.

According to a further embodiment of the electric drive system according to the invention, the switching elements can each comprise power semiconductor switches, preferably MOSFET switches or IGBT switches. These switches are particularly able to withstand stress and can be reliably actuated.

According to a further embodiment of the electric drive system according to the invention, the drive system can furthermore comprise a control device which is designed to actuate the power semiconductor switches of the first inverter and the second inverter, wherein the control device is disposed on a central control circuit board for the first inverter and the second inverter.

### BRIEF DESCRIPTION OF THE DRAWINGS

Further features and advantages of embodiments of the invention ensue from the following description with reference to the attached drawings.

In the drawings:

FIG. 1 shows a schematic depiction of an exemplary conventional electric drive system; and

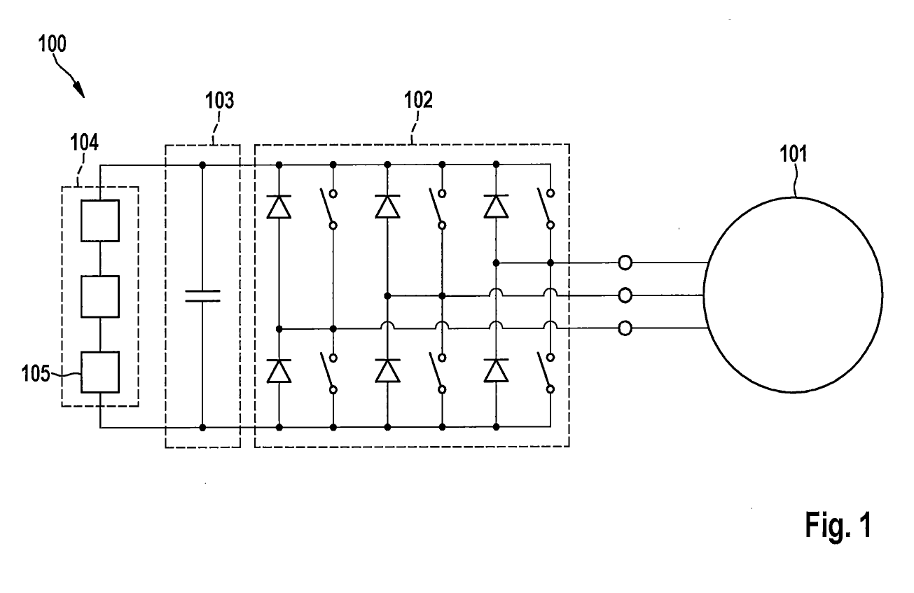

FIG. 2 shows a schematic depiction of an electric drive system according to a further embodiment of the present invention.

Identical reference signs generally denote similar or similarly functioning components. The schematic depictions shown in the figures are only of an exemplary nature and are depicted in an idealized manner for reasons of clarity. It goes without saying that the depicted components are only used to illustrate principles and functional aspects of the present invention.

### DETAILED DESCRIPTION

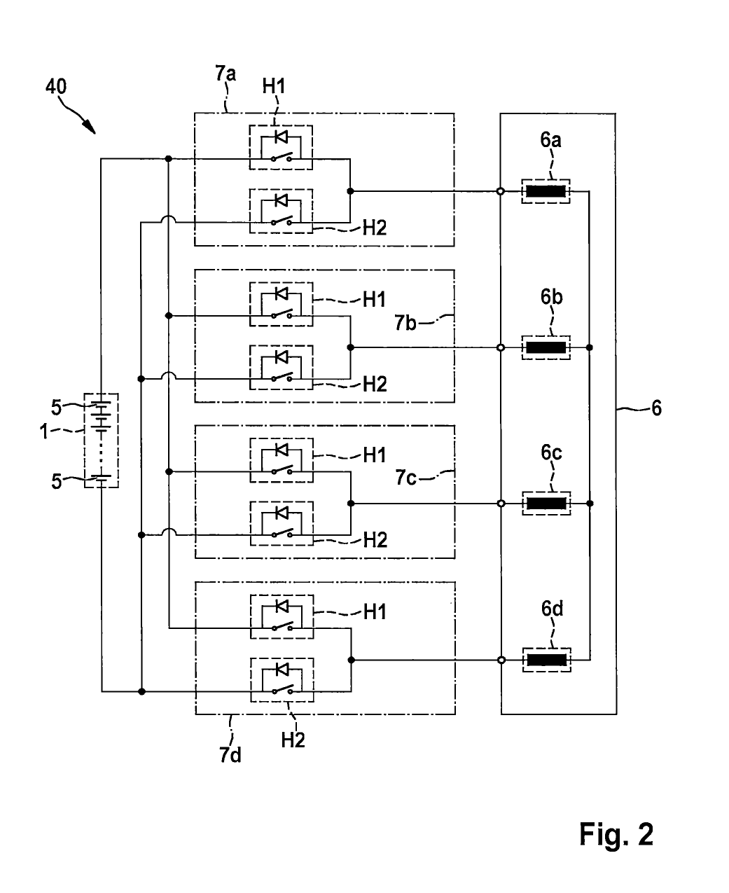

FIG. 2 shows ultimately a schematic depiction of an electric drive system 40, comprising an n-phase electric machine, n>1, which, for example, can be a switched reluctance machine or a three-phase machine. The electric machine has, by way of example, four single-phase wiring strands 6a to 6d, which can be coupled to one another at the neutral point thereof. The electric drive system 40 furthermore has an inverter system consisting of four inverters 7a to 7d coupled in parallel. In so doing, each of the four inverters 7a to 7d, at the output connections thereof, feeds respectively one of the single-phase winding strands 6a to 6d of the electric machine 6.

The inverters 7a to 7d each have a half-bridge topology, i.e. each of the inverters represents a single-phase, self-piloted inverter which comprises a symmetrical half bridge consisting respectively of two power semiconductor switches H1 and H2 in a series circuit. The power semiconductor switches can, for example, be MOSFET switches or IGBT switches. It is, however, also thereby possible to use any other type of switching elements as switches H1 and H2 and at the same time to connect a free-wheeling diode in parallel to each switching element H1 and H2. The phase of the single-phase winding strands 6a to 6d is coupled respectively to a center tap of the half bridge of the inverters 7a to 7d.

The inverters 7a to 7d can thereby be implemented either as separate inverter units or also in a common inverter module. In the latter case, a single inverter module comprising four symmetrical half bridges can be provided which is coupled in a suitable manner to the electric machine 6. A (not explicitly depicted) control device, which, for example, can be implemented on a common control circuit board, can be used for the actuation of the power semiconductor switches H1, H2.

The inverters 7a to 7d can, for example, be supplied with an electrical DC voltage by means of a common DC voltage source 1, for example a traction battery of an electric vehicle. To this end, the DC voltage source 1 can, for example, comprise a series circuit consisting of battery modules 5, the number of which is depicted as 3 in FIG. 2 only by way of example. Any other number of battery modules 5 can likewise be possible. It is likewise possible to connect more than four inverters in parallel, in particular if the electric machine 6 has more than four winding strands 6a to 6d. To this end, each of the inverters can be associated with one of the winding strands and be electrically connected to the same.

By using a plurality of basically similar inverters 7a to 7d, the phase currents can be kept the same through each of the inverters 7a to 7d, even if the number of the inverters 7a to 7d is greater than one. As a result, the current carrying capacity of the power semiconductor switches H1, H2 of the inverters 7a to 7d does not have to be increased with respect to conventional power semiconductor switches. In addition, each of the inverters 7a to 7d can also be supplied from a separate DC voltage source 1. A feed of a four-phase electric machine 6, as depicted in FIG. 2, can, for example, also take place by means of two separate DC voltage sources 1, which in this variant can advantageously in each case alternately feed adjacent inverters. That means adjacent winding strands of the electric machine 5 are served respectively by different DC voltage sources 1.

In the drive system depicted in FIG. 2, the electric machine 6 can, for example, be a synchronous or asynchronous machine, a reluctance machine or a brushless DC motor (BLDC). It may also be possible to use the electric drive system 40 of FIG. 2 in stationary systems, for example in power plants, in electrical power generation plants, such as wind power plants, photovoltaic plants or power-heat coupling plants, in energy storage plants, such as, for example, compressed air storage power plants, battery storage power plants, flywheel accumulators, pumped storages or similar systems. A further option for use of the electric drive system 40 of FIG. 2 is in passenger vessels or commercial transport vessels which are designed to move on or under the water, for example ships, motor boats or something similar.

1. An electric drive system (40), comprising:
an n-phase electric machine (6), n>1, which has at least two single-phase winding strands (6a, 6b);
a first inverter (7a), the output connection of which is connected to the phase connection of a first of the single-phase winding strands (6a) of the electric machine (6);
at least one second inverter (7b), the output connection of which is connected to the phase connection of a second of the single-phase winding strands (6b) of the electric machine (6); and
a DC voltage source (1) which has a plurality of series-connected battery modules (5), output connections (1) of which are respectively connected to the input connections of the first inverter (7a) and to the input connections of the second inverter (7b), so that the first inverter (7a) and the second inverter (7b) are arranged in parallel.

2. The electric drive system (40) according to claim 1, wherein the first and the at least one second inverter (7a, 7b) each represent a single-phase, self-piloted inverter, which comprises a symmetrical half bridge including respectively two power semiconductor switches (H1, H2) connected in series.

3. The electric drive system (40) according to claim 2, wherein the power semiconductor switches (H1, H2) are MOSFET switches or IGBT switches.

4. The electric drive system (40) according to claim 2, further comprising:
a control device, configured to actuate the power semiconductor switches (H1, H2) of the first inverter (7a) and the second inverter (7b),
wherein the control device is disposed on a central control circuit board for the first inverter (7a) and the second inverter (7b).
